(19) United States
(12) Patent Application Publication
(10) Pub. No.: US 2013/0284840 A1
(43) Pub. Date: Oct. 31, 2013

(54) ROLLER PRESS

(71) Applicants: Andreas Packeisen, Gladbeck (DE); Axel Höfter, Bochum (DE); Eggert De Weldige, Velbert (DE)

(72) Inventors: Andreas Packeisen, Gladbeck (DE); Axel Höfter, Bochum (DE); Eggert De Weldige, Velbert (DE)

(73) Assignee: MASCHINENFABRIK KOPPEN GMBH & CO. KG, Hattingen (DE)

(21) Appl. No.: 13/876,530

(22) PCT Filed: Sep. 29, 2011
(86) PCT No.: PCT/EP11/04878

§ 371 Date: Jul. 3, 2013

(30) Foreign Application Priority Data
Sep. 29, 2010 (DE) 20 2010 013 735.7
Nov. 30, 2010 (DE) 10 2010 052 935.4

(51) Int. Cl. B02C 4/30; B21D 53/00

(52) U.S. Cl. CPC B02C 4/305; B21D 53/00
USPC 241/235; 241/295; 29/895.21

(57) ABSTRACT

A roller press, in particular for processing highly abrasive materials, includes at least two press rollers, each of which is provided with a wear protection layer arranged on a base body. The wear protection layer includes plate-shaped and pin-shaped wear resistant material elements. The plate-shaped, wear resistant material elements are applied to surfaces of two opposed edge areas of each base body by sintering with or without pressure, preferably by a hot isostatic pressing operation. The pin-shaped wear resistant material elements are arranged in a central section of each base body extending between the edge areas. A method of producing a wear protection layer, in particular for a press roller, is also provided.

### CROSS-REFERENCE TO RELATED APPLICATIONS

This application is a Section 371 of International Application No. PCT/EP2011/004878, filed Sep. 29, 2011, which was published in the German language on Apr. 26, 2012, under International Publication No. WO 2012/052110 A1 and the disclosure of which is incorporated herein by reference.

### BACKGROUND OF THE INVENTION

The invention relates to a roller press, in particular for processing highly abrasive materials, comprising at least two press rollers, each of them provided with a wear protection layer arranged on a base body. The wear protection layer comprises plate-shaped and pin-shaped wear resistant elements. The invention further relates to a method of producing a wear protection layer.

Roller presses of the type in question are used in the prior art for a great variety of purposes, in particular for compacting and crushing. Depending on the profile of the press rollers, the loads occurring are not only a compressive load on the materials to be processed but also a sliding load on the roller surface. In order to protect the roller surface against these loads and the resultant wear, it is known to apply a wear protection to the surface. This kind of wear protection may e.g. comprise cylindrical hard metal pins, which are very frequently used in practice and which are installed in a softer base matrix. The hard metal pins form together with the pressed-in material to be ground an autogenous wear protection layer. In the case of such known roller presses, the risk that the pins may break out is very high. In particular, in the edge area of the press roller, there is an increased risk of breaking out. This is the reason for the fact that the pin-like structuring of the surface is normally not continued up to the edge of the press roller, but the edge is protected by additional anti-wear measures. A possible solution for protecting edge areas are e.g. mechanically anchored hard metal plates or additional build-up welding. However, chipping, break-out or flaking of the edge protection occur during operation also in the case of these additional solutions.

One example of such a known roller press is described e.g. in EP-A-0 516 952. This roller press can, in more detail, be configured such that numerous blind holes having pin-shaped material pieces inserted therein are arranged in the circumferential area of the roller press. The main part of the pin-shaped material piece is located in the roller base body, whereas the rest projects therefrom. The spaces between the pin-shaped material pieces protruding from the roller base body in a hedgehog-like manner can be filled with a ceramic material that has plastic added thereto. A different solution described in EP-A-0 516 952 is so conceived that plate-shaped as well as pin-shaped material pieces are embedded in the area of the roller surface. In this embodiment, the inserts are flush with the roller shell surface, so that additional material can here not be provided between the inserts.

A different wear protection concept for roller presses is, as described e.g. in DE 942207 U1, so conceived that wear resistant tiles are applied to the base body, the individual tiles having gaps formed between them into which a material of different wear resistance is introduced. Press rollers configured in this way displayed a particularly high durability.

Although a large number of different, more or less disadvantageous wear concepts are already used in this field, there is still a need for improving the wear resistance of the rollers still further, so as to keep the downtimes and the resultant loss of production as small as possible. In addition, the roller press should be applicable for all cases of use (compacting and crushing) and it should be easy to manufacture.

### BRIEF SUMMARY OF THE INVENTION

For a roller press, in particular for processing highly abrasive materials, comprising at least two press rollers, each of them provided with a wear protection layer arranged on a base body, and the wear protection layer comprising plate-shaped and pin-shaped, wear resistant material elements, the object of the present invention is achieved in that the plate-shaped, wear resistant material elements are applied to the surfaces of the two opposed edge areas of each press roller by sintering with or without pressure, preferably by a hot isostatic pressing operation, and that the pin-shaped, wear resistant components are arranged in the section of each base body extending between the edge areas.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. In the following, embodiments of the present invention will be explained in more detail making reference to a drawing. It should be understood, however, that the invention is not limited to the precise arrangements and instrumentalities shown.

In the drawings:

FIG. 1 shows, in a fragmentary sectional view, a press roller for a roller press with edge areas of the base body that have been reduced in diameter, according to one preferred embodiment of the present invention;

FIGS. 2a and 2b show, in a fragmentary sectional view and in a top view, respectively, the press roller shown in FIG. 1, after application of plate-shaped material elements and after the insertion of a wear resistant powder material filling intermediate gaps;

FIG. 3 shows, in a fragmentary sectional view, the press roller shown in FIGS. 1 and 2, after hot isostatic pressing and additional machining for obtaining a planar surface;

FIG. 4 shows, in a sectional view, the press roller shown in FIGS. 1 to 3, after the execution of a diameter reduction in the region between the edge areas as well as after the formation of holes;

FIG. 5 shows, in a sectional view, the press roller shown in FIGS. 1 to 4, after the insertion of pin-shaped material elements in the holes;

FIGS. 6a to 6f show, in a sectional view, a method of producing a press roller according to a preferred embodiment of the present invention;

FIG. 7 shows a top view of a detail of the base body of a press roller, after the formation of pocket-like recesses in the edge areas, according to a preferred embodiment of the present invention;

FIGS. 8a to 8c show, in a sectional view, a method for producing a press roller according to a preferred embodiment of the present invention;

FIGS. 9a and 9b show side views of additional lateral recesses of the press rollers according to FIGS. 9a and 9b;

FIG. 10 shows a sectional view through another embodiment of a press roller; and

FIG. 11 shows a sectional view through another embodiment of a press roller.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the device and designated parts thereof. Unless specifically set forth herein, the terms “a”, “an” and “the” are not limited to one element but instead should be read as meaning “at least one”. The terminology includes the words noted above, derivatives thereof and words of similar import.

The roller press according to the present invention thus preferably comprises at least two press rollers having different wear protection concepts in the area of the edges as well as in the intermediate central area of the press rollers, so as to optimally protect the different press roller application areas. The use of plate-shaped material elements, which were applied to the roller surfaces preferably by hot isostatic pressing, in combination with the pin-shaped material elements incorporated in the intermediate central area of the base body thus provides optimum wear protection for a great variety of cases of use. The wear protection is preferably characterized by high durability and short downtimes.

Since the plate-shaped material elements in the area of edge are applied to the surface preferably by hot isostatic pressing, a bond to the roller base body can be achieved, which is so strong that the individual components of the edge wear layer cannot be released therefrom. The frequently occurring problems of breaking out of the pin-shaped elements or of other wear protection components are thus avoided, in particular in the area of the press roller edges. The use of pin-shaped material elements in the central area of the press rollers has stood the test for a long time.

The advantage of hot isostatic pressing is that the highest possible interfacial strength can be accomplished in this way. Hence, at least the strength of the weaker partner of the materials in question will here preferably always be achieved.

In addition, it turned out that various press roller production methods, which will be explained in more detail hereinafter, are available. These production methods also allow these two wear protection concepts, which are based on different principles, to be produced on a single press roller within a comparatively short time and at a reasonable price.

According to another preferred embodiment, the hard elements arranged in the edge areas may be configured as tiles having a predetermined contour, e.g. quadrangular, pentagonal, preferably, however, hexagonal. This kind of predetermined contour and arrangement of the edge tiles provides space for an alternating positioning of the pin-shaped material elements between the edge areas and prevents, during operation, the wear-conditioned formation of a tangential, circumferentially extending groove.

The plate-shaped, wear resistant material elements (5) may advantageously be configured as one-piece elements, preferably in a ring shape.

A preferred embodiment may be so conceived that the edge areas preferably occupy 5 to 25% of the overall area of the active wear protection layer. This percentage proved to be useful for preventing the edge areas from breaking out and for thus guaranteeing a sound condition of the wear protection layer.

Another preferred embodiment may be so conceived that the pin-shaped material elements are preferably hard metal pins or pins consisting of hard metal-like materials, e.g. cermets. These pins have already proved to be useful in practice for a long time. The production of these pins corresponds to the powder metallurgical prior art so that they can be produced at a comparatively reasonable price.

According to an advantageous embodiment, the plate-shaped material elements may preferably consist of metal-matrix composites with up to 80% by weight of coarse further phases, preferably from the group of carbides, borides and nitrides. These materials proved to be particularly useful in practice.

Another preferred embodiment may be so conceived that the pin-shaped material elements are, preferably releasably, installed in holes in the base body. The arrangement of the holes determines the arrangement and distribution of the pins on the base body. The pins can thus be inserted comparatively easily, and also damaged pins can be replaced in a simple way. If the pins are to be fixed in a non-releasable manner, they could be connected to the base body; e.g., by means of hot isostatic pressing.

According to a further preferred embodiment, the surfaces of the pin-shaped material elements and the surfaces of the plate-shaped material elements may preferably be arranged in one plane. The load applied by the material to be processed is thus preferably uniformly distributed over the surfaces. Likewise, material that has already been processed can be deposited in the areas between the pin-shaped material elements projecting beyond the base surface of the press roller, so as to form an autogenous wear protection.

Another preferred embodiment may be so conceived that an additional zone material is preferably arranged on the base body in the section disposed between the edge areas, the surface of the zone material being arranged below the surface of the pin-shaped material elements or in one plane therewith. The zone material may exhibit a wear resistance which is different from that of the pin-shaped and plated-shaped material elements, so that areas of different wear protection characteristics are provided. The pins may preferably be fully embedded in the zone material or project beyond the latter. The zone material may be applied preferably by hot isostatic pressing. The zone material consists preferably of a metallic or metal-ceramic powder type or of a powderlike material. If the zone material or rather the surface of the zone material is to be arranged below the surface of the pin-shaped elements, the zone material can be machined (i.e., reduced in diameter), so as to achieve the predetermined height of the zone material before the pin-shaped material elements are arranged. Appropriate post-machining proved to be useful, since it is thus possible to apply the plate-shaped material elements as well as the zone material in a single hot isostatic pressing operation, so that the method can be optimized as regards time requirements. In this context, it turned out that the zone material should preferably have a strength which allows subsequent machining.

A preferred embodiment of the invention is so conceived that, in the area of the edges, the diameter of the base body may preferably be reduced to a predetermined extent prior to the application of the plate-shaped material elements, so as to obtain at least one step. After the application of the plate-shaped material elements, the latter may extend in one plane with the original diameter of the base body or they may project beyond the original height of the edge areas. It is thus preferably guaranteed that, depending on the requirements to be satisfied in the particular case of use, the plate-shaped material elements may be produced in any height, without, however, projecting beyond the surface of the future component base surface further than the pin-shaped material elements provided for the area between the edges. If the edge is formed with a step-shaped recess, the deeper step should be formed preferably directly adjacent the lateral surfaces of the base body. The lateral surfaces of the base body can thus be protected by installing additional wear protection elements. These additional elements are preferably arranged below the plate-shaped material elements.

According to another preferred embodiment, the base body of the press rollers may preferably be formed of at least two base body segments, which preferably define a closed ring and which are preferably releasably arranged on a base element. On the one hand, it is thus possible to restore, if parts of the wear protection layer should fail, the base body of the press roller in a particularly easy manner by a simple replacement of parts, and, on the other hand, the base layer can be produced easily even in the case of comparatively large press roller diameters.

According to another embodiment, the wear protection layer may preferably be applied to a closed bandage forming the base body, the closed bandage being arranged on the base element of the roller in form-fit engagement or in frictional engagement therewith and preferably being associated with the base element. On the basis of this structural design, the individual wear elements can preferably be arranged on the base body with comparatively little effort. Especially in the case of a shrunk-on bandage, the formation of cracks caused by shrinkage stresses can be avoided by an appropriate adjustment of the material in question.

According to another embodiment, additional wear elements may preferably be arranged in the lateral surfaces of the base body below the plate-shaped, wear resistant material elements in reception openings formed in the lateral surfaces. This allows an additional protection of the lateral surfaces of the base body, so as to substantially increase the wear resistance of the press roller as a whole.

According to an advantageous embodiment, the lateral wear protection elements may preferably be configured as plate-shaped elements, and the respective shape or configuration can be chosen according to requirements, e.g. rings, plates, polygonal elements, etc. Likewise, a powdery material may be applied and converted into appropriate wear protection elements preferably by hot isostatic pressing.

A further embodiment of the present invention is so conceived that the base body of the press rollers preferably consists of a plurality of rings, which are arranged on a base element of the press roller in form-fit engagement or in frictional engagement therewith, the respective edge areas each being formed by a separate ring whose circumference has applied thereto the plate-shaped material elements. This embodiment is preferably characterized by a particularly simple production mode of the press roller, since the individual elements of the press roller (i.e., the edge areas as well as the central area) simply have to be pushed on. This will preferably also lead to a substantial reduction of time in the case of maintenance and repair.

The method used according to the present invention for producing a wear protection layer, in particular for a roller press used for processing highly abrasive materials, preferably comprises the following steps:
applying plate-shaped, highly wear resistant material elements, which have been produced by sintering, cold isostatic pressing (CIP) or hot isostatic pressing (HIP), or bulk powder comprising at least one component, to the edge areas of a base body of the press roller;
applying the plate-shaped material elements and/or the bulk powder comprising at least one component to the base body as edge elements, preferably by HIP;

forming holes in the base body section arranged between the edge elements; and

inserting pin-shaped, highly wear resistant material elements in the holes formed, so that these elements project beyond the surface of the base body with their surfaces extending in one plane with the surface of the edge elements.

This method is preferably characterized by a particularly small number of methods steps and, consequently, by efficient and prompt production. This also allows production costs to be held as low as possible.

This basic method can be modified by incorporating additional preferred method steps. In order to clearly specify the individual modified sequences of method steps also with respect to their sequence in time, all the individual method steps, including those that have already been mentioned in advance, will be enumerated in the description of the methods following hereinafter.

Accordingly, another preferred method provides the following steps:

pre-machining the base body of the press roller so as to obtain a planar surface;

applying the plate-shaped, highly wear resistant material produced by sintering, CIP or HIP, to the two opposed edge areas of the pre-machined base body;

filling the intermediate gaps between the plate-shaped, highly wear resistant material elements with a wear resistant, one or multi-component material (intermediate gap material);

filling the base body section arranged between the edge areas with a wear resistant, one or multi-component material (zone material);

applying the plate-shaped material elements, the zone material and the intermediate gap material to the base body, preferably by hot isostatic pressing, so that the surfaces of the edge elements formed by the plate-shaped material elements, of the zone material and of the intermediate gap material extend substantially in one plane;

forming holes in the zone material arranged between the edge elements as well as in the base body of the press roller, and

inserting pin-shaped, highly wear resistant material elements in the holes formed, preferably such that these elements extend in one plane with the edge elements and the zone material.

This method differs from the basic method with respect to an additional step of preparing the base body. This pre-machining can be accomplished, for example, by turning or by machining the base body in some other known way. Furthermore, the intermediate gaps between the individual plate-shaped material elements arranged in the edge areas are additionally filled with a wear resistant, one or multi-component material, the so-called intermediate gap material. The material in the intermediate gaps may here have a wear resistance different from that of the plate-shaped material elements so that the outer circumference provides wear protection with different wear characteristics, by means of different loads can efficiently be coped with. Likewise, the base body section arranged between the edge areas (i.e., the central section) can be filled with a wear resistant, one or multi-component material (zone material). As regards this zone material, it should preferably have a wear resistance different from that of the plate-shaped, highly wear resistant material, preferably a wear resistance allowing further machining of the zone material, for example, by means of turning. Thus, the height of the zone material can, after the application of the individual material elements, be changed such that a predetermined dimension is obtained.

In this connection, the zone material should preferably be machined, such that the resultant surface of the zone material is located lower than the surface of the edge elements by a predetermined amount, so that the pin-shaped, highly wear resistant material elements are arranged in the holes, such that the surface of the pin-shaped material elements extends beyond the surface of the zone material and extends preferably in one plane with the surface of the edge elements. Thus, material is allowed to accumulate between the individual pins whereby the wear layer is additionally influenced.

Another preferred method according to the present invention comprises the following steps:

preparing the base body by forming therein regularly extending lateral recesses in the opposed edge areas of the base body,

fitting the plate-shaped, highly wear resistant material elements or a bulk powder comprising at least one component into the recess in the edge areas of the base body,

where appropriate, filling the intermediate gaps between the plate-shaped, highly wear resistant material elements and the recesses with a powdery, wear resistant, one or multi-component material (intermediate gap material),

applying the plate-shaped material elements and/or the bulk powder comprising at least one component to the base body, preferably by HIP,

where appropriate, machining the section between the edge areas so as to reduce the diameter of the section extending between the edge areas to such an extent that the resultant surface is located lower than the surface of the edge elements by a predetermined amount,

after the hot isostatic pressing or the reduction of the diameter of the section between the edge areas, forming holes in the base body section arranged between the edge areas;

inserting pin-shaped, highly wear resistant material elements in the holes formed, so that these elements project beyond the surface of the base body and their surface extends in one plane with the surface of the edge elements.

This method comprises the step of systematically forming in the edge area of the base body lateral recesses extending up to and into the lateral surfaces of the base body; i.e., the recesses end in the lateral surfaces of the base body and they are configured such that they are laterally open and open at the top. These recesses, which are arranged at regular intervals, can then have inserted therein either plate-shaped material elements or bulk powder. If plate-shaped material elements are used, the intermediate gaps between the individual plate-shaped elements and the walls of the recess can additionally be filled with a powdery material so that the recess is filled completely. Application of the material elements and of the powdery material or the bulk powder then takes place by means of hot isostatic pressing.

A desired wear protection, adapted to the needs of the respective field of use, can here efficiently be provided by selecting the shape of the recess.

Yet another preferred method comprises the following steps:

reducing the diameter of the base body of the press roller in the region of the two opposed edge areas to a predetermined extent;

applying a highly wear resistant material to the edge areas of the base body in the form of a bulk powder comprising at least one component so as to form a planar and continuous edge element;

where appropriate, applying an identical or a different bulk powder comprising at least one component so as to form a planar and continuous section between the edge areas (zone material);

arranging the bulk powder comprising at least one component on the reduced-diameter edge areas and, where appropriate, on the section between the edge areas, preferably by hot isostatic pressing;

after hot isostatic pressing, partially removing, where appropriate, the zone material in the sections between the edge areas so that the resultant surface is located lower than the surface of the continuous edge zone by a predetermined amount;

after hot isostatic pressing or after the removal of the zone material, forming holes in the base body section arranged between the edge areas; and

inserting pin-shaped, highly wear resistant material elements in the holes formed, so that the surface of these elements extends in one plane with the surface of the continuous edge elements and in one plane with the surface of the zone material, or extends beyond the surface of the zone material.

Other than in the case of the previously described modifications of the method, the diameter of the base body is here preferably first reduced to a predetermined extent in the region of the two opposed edge areas; i.e., the two edge areas are configured as steps. This area of reduced diameter has applied thereto a highly wear resistant material in the form of a bulk powder so as to provide here a continuous, planar edge element by means of a further process, in particular by hot isostatic pressing.

Hence, this method provides the formation of a continuous edge zone and the method can be executed more speedily, since it is not necessary to arrange individual plate-shaped elements side-by-side on the base body. The characteristics of the edge zone can here be adjusted efficiently by a purposeful selection of the powder materials.

If also the area between the edge zones is to be filled with the same material, even this step can be simplified substantially, since the powder mixture can be applied to both areas in one step, and since also compacting and bonding to the base body is carried out by a single hot isostatic pressing operation.

This edge element may here be limited exclusively to the reduced-diameter area, or it may extend beyond the surface of the base body; i.e., also beyond the surface of the intermediate central section of the base body. Likewise, this central area may, in turn, have applied thereto a bulk powder having preferably a different wear resistance.

A further advantageous method can be so conceived that the lateral surfaces of the base body have formed therein additional recesses, which are adapted to accommodate additional wear elements. These additional wear elements are then arranged below the edge elements.

In this respect, the diameter of the base body may be reduced in size with two different diameters in the region of the two opposed edge areas. The reduction of the diameter of the two press rollers in the region of the two opposed edge areas preferably takes place in two steps; i.e., the first reduction of the diameter of the two press rollers is followed by a second reduction of the diameter of the press rollers exclusively in a section directly adjacent the lateral surfaces. The surface of the edge areas located directly adjacent the sides of the base body is therefore preferably located lower than the surface of the previously machined edge areas by a predetermined amount.

Following this, the recesses provided in the lateral surfaces may be filled in a first step. This filling may be executed with plate-shaped segments, powder or other suitable elements. In so doing, filling may be executed only up to the surface of the depressed edge areas or, in the case of a powder, the whole depression of the lateral surfaces as well as of the edge areas may be filled.

In the case of all the above described methods, the hot isostatic pressing may also be replaced by sintering with or without pressure.

Summarizing, it can therefore be stated that, by means of sintering with or without pressure, an intimate connection between the individual materials is preferably accomplished, irrespective of whether the material in question is used in the form of a prefabricated element or in the form of powder.

According to a further preferred embodiment, the plate-shaped material elements may preferably be hard elements, produced by a sintering process or cold or hot isostatic pressing. Likewise, the material elements may also be obtained by casting processes. In addition, these material elements may also be produced, e.g. by rolling or pressing, in particular with high heating rates. By prefabricating suitable plate-shaped material elements, the time required for the actual production process on the press rollers can preferably be reduced substantially. When sintering or isostatic pressing are employed, the use of purposefully selected different powder types additionally allows a combination of the characteristics of the various powder types and, consequently, a concrete adjustment of the individual hard elements to the intended use.

Summarizing, it can be stated that the above specified methods offer the advantage that the wear protection layer can be applied in different ways which are easy to realize. By changing a few process parameters or material parameters, the wear protection layer can, in addition, be configured to have very different wear characteristics. In this way, the wear protection layer of the press roller can be adapted precisely to the materials to be processed.

Advantageously, the plate-shaped, wear resistant material elements can preferably be produced, before they are applied to the base body, as plate-shaped hard elements by cold or hot isostatic pressing or by a sintering process. This allows the hard elements to be configured in any desired shape and with any desired profile.

Likewise, the plate-shaped, wear resistant material elements may, by means of a single hot isostatic pressing operation, also be formed in the desired shape directly on the edge areas of the base body and connected to the edge areas.

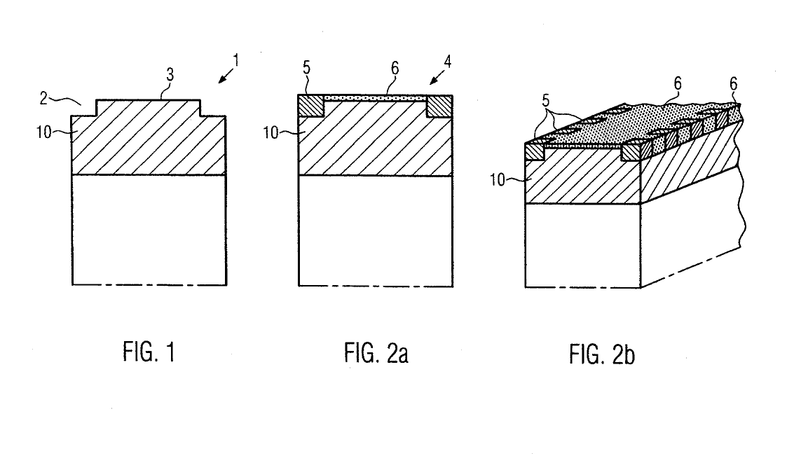

FIG. 1 shows the base body 10 of a press roller 1, the base body being configured as a bandage. Likewise, the base body may also be configured as a solid body. As can be seen, the diameter of the base body has been reduced to a predetermined extent in the area of the two opposed edges 2; i.e., the base body section 3 extending between the two edge areas 2 projects beyond the edge areas 2 in a bridge-like manner. This reduction of diameter can be accomplished by known methods, e.g. by subjecting the base body to turning. The recess formed in the edge areas already defines the width of the edges so that the shape of the wear protection layer can preferably no longer be changed.

Following this, the recessed edge areas 2 have applied thereto a wear protection layer consisting of powder metallurgically produced, highly wear resistant, plate-shaped elements of material 5 as well as of an intermediate gap-filling, wear resistant, one- or multi-component powdery material 6. The wear behavior of the materials selected may here be adapted to the characteristics of the material to be processed. Ideally, the two materials used for the material elements 5 and for the gaps 6 exhibit different wear behaviors so that a surface profile will form in the edge areas of the press roller during operation. The plate-shaped material elements may have been produced in advance by HIP, CIP, sintering processes or, if desired, other processes, and their height may extend beyond the bridge-shaped section 3 that has been produced in advance by machining.

The material elements 5 may also have been provided in the form of already previously produced plate-shaped hard elements, which have been produced by hot isostatic pressing. In the following, the terms material elements and hard elements will be used as synonyms and they will both be identified by the reference numeral 5. The plate-shaped hard elements 5 are arranged on the edge areas of the press roller in a tile-like fashion and, subsequently, the resultant intermediate gaps are filled with a wear resistant powder material 6. The tiles are here preferably advantageously shaped such that they cover the edge areas substantially completely (i.e., in particular with a continuous edge on the end edges of the base body) and, advantageously, also such that they terminate at the end of the recess formed at the edge areas 2. To this end, the hard elements may be placed in abutting relationship with one another in a mosaic-like fashion so as to achieve an appropriate result. The use of individual hard elements preferably allows not only the use of differently shaped elements for achieving an appropriate result, but it is also possible to determine the size and the number of intermediate gaps depending on the respective case of use.

Subsequently, the hard elements as well as the intermediate material are preferably fixed to the base body 10 by hot isostatic pressing. Diffusion zones, through which the individual materials are fixedly bonded to one another, are thus formed at the locations where the hard element material and the intermediate gap material are in contact with the base body, as well as at the locations where the hard element material and the intermediate gap material are in contact with one another. In this way, the wear behavior of the edge areas can be adapted to the characteristics of the material to be processed.

Materials which proved to be useful for the hard elements as well as for the intermediate gaps are, for example, highly wear resistant powder metallurgical materials, which may also contain, for example, components of a ceramic nature.

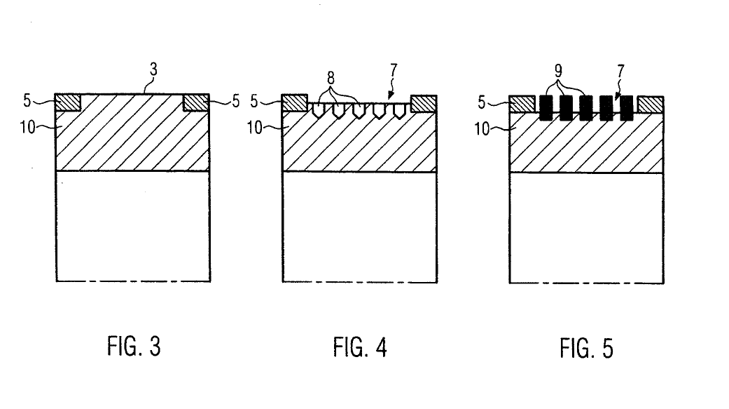

FIG. 3 shows the condition of the roller base body after hot isostatic pressing. Both the hard elements 5 as well as the intermediate gap material 6 are fixedly bonded to the base body in this condition. In the representation shown in FIG. 3, the intermediate gap material 6 has been fully removed in the area of the bridge-shaped section 3. This, however, is only a preferred embodiment. Depending on the respective field of use, the intermediate gap material 6 may also still exist or it may only have been removed partly.

When hot isostatic pressing has been executed, the section 3 extending between the edge areas 2 or the plate-shaped material elements 5 arranged thereon can be machined so as to accomplish a reduction of the diameter of section 3. FIG. 4 shows the base body after execution of this diameter reduction. This diameter reduction can be executed e.g. by pocket milling. As can clearly be seen from FIG. 4, section 3, which extends between the edge areas or material elements 5, defines a trough-like depression 7. The surface of section 7 is located lower than the surface of the material elements 5 by a predetermined amount. In this depressed area, holes 8 are formed in the manner known, the holes being used for accommodating pin-shaped, highly wear resistant elements.

A finished press roller 1 is shown in FIG. 5. Pin-shaped, highly wear resistant elements 9 now extend into the holes provided in the base body 10. The holes are dimensioned such that most of the pin-shaped elements extends into the base body 10, whereas only a small part of the pin-shaped body 9 projects beyond the surface. In the finished condition, the surface of the pin-shaped material elements 9 is preferably arranged in one plane with the surfaces of the hard elements 5.

In all of the embodiments described herein, the pins 9 can be arranged releasably in the holes so that, if pins should be subjected to wear or get damaged, they can be replaced by new pins at any time. Likewise, the pins may, of course, also be anchored in a non-releasable manner. Also the pins are preferably implemented as hard elements, and they may consist of metal-matrix composites with up to 80% by weight of coarse further phases, preferably from the group of carbides, borides and nitrides, or of hard metal or hard metal-like materials (e.g. cermets).

During operation, material to be processed accumulates between the individual pins as well as between the pins and the edge areas, and supports thus the wear protection layer.

According to another embodiment, the intermediate gap material (i.e. the surface of the intermediate gap material) may also extend in one plane with the surface of the hard elements. In this case, the pins are preferably fully countersunk; i.e., the surface of the pins extends in the same plane as the surfaces of the hard elements and of the intermediate gap material. The pins according to this embodiment are fully embedded in the base body and in the intermediate gap material.

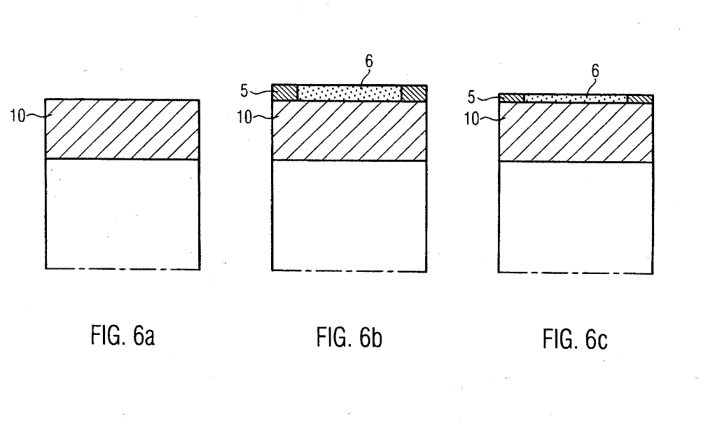

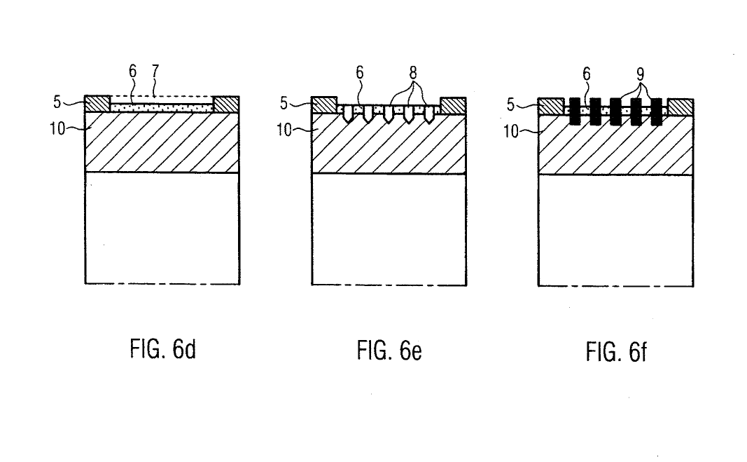

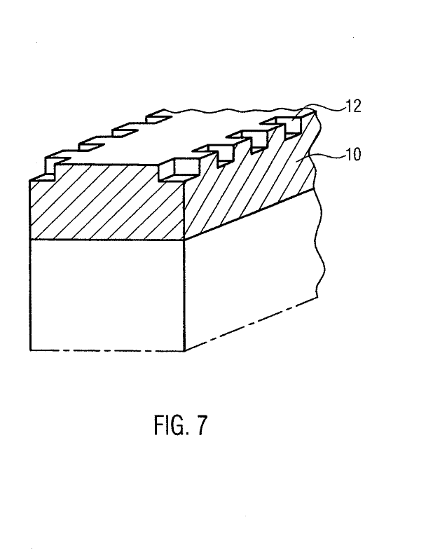

In contrast to the above embodiments, the highly wear resistant, plate-shaped material elements 5, which were previously produced, e.g., by HIP, CIP or sintering processes, may also be applied directly to the surface of a base body 10 that has previously been planarized; i.e., the diameter of the base body 10 has not formed therein any steps but remains unchanged. This kind of embodiment is shown in FIG. 6a. In a further method step, a wear resistant, one- or multi-component powdery material 6 is preferably then applied to the intermediate gaps between the applied plate-shaped material elements 5, which correspond to the hard elements, as well as to the space formed between the edge areas (cf. also FIG. 6b). The whole arrangement is subsequently treated by HIP so that not only the hard elements but also the whole powdery material, including the powdery material located between the hard elements, are bonded to one another and to the surface of the base body.

When hot isostatic pressing has been executed, the surface of the base body 10 is preferably defined by the hard elements 5 arranged in the edge areas 2, including the intermediate gap material 6, as well as by a surface layer provided by the powdery material, as shown in FIG. 6c.

In order to prepare the base body for the introduction of the pin-shaped, highly wear resistant material elements and prior to the formation of the respective holes, the surface section 3 located between the edge areas, which consist of the hard elements and the intermediate gap material, must first be reduced to a predetermined extent so as to produce a depression between the edge areas 2. The material can here be removed by known measures, e.g. by pocket milling (FIG. 6d).

Subsequently, the holes 8 for the pin-shaped material elements 9 are formed. FIG. 6e shows that these holes may extend through the surface layer 3 down to and into the base body 10. The last method step (FIG. 6f) shows the base body after the pin-shaped material elements 9 have been installed in the holes 8. Also in this case, the surface of the pin-shaped material elements 9 extends in one plane with the surface of the hard elements 5 arranged in the edge areas.

Other than in the case of the above described embodiments, the edge areas of the base body may also be configured as structured surfaces. It is possible to produce by conventional machining (e.g. cutting) regularly formed lateral recesses 12 in the opposed edge areas, the recesses defining then pocketlike openings. This kind of embodiment is shown in FIG. 7. The plate-shaped, highly wear resistant material elements 5 produced by sintering, CIP or HIP, or bulk powder comprising at least one component can then be fitted into the pockets 12 formed. The shape of the pockets 12 shown here is only an exemplary embodiment. Likewise, the pocket contour may also be quadrangular, pentagonal, hexagonal or polygonal, and it may also be round or rounded.

When the plate-shaped, highly wear resistant material elements 5 produced by sintering, HIP or CIP have been fitted in, the intermediate gaps between the elements and the pocketlike openings 12 can be filled with a wear resistant, one- or multi-component material, the intermediate gap material.

The further production steps then correspond to the above described ones; i.e. the plate-shaped material elements 5 and/or the bulk powder are applied to the base body 10 by HIP in a further method step. After hot isostatic pressing, holes 8 can be formed and pin-shaped elements 9 can be fitted in, analogously to the above described methods.

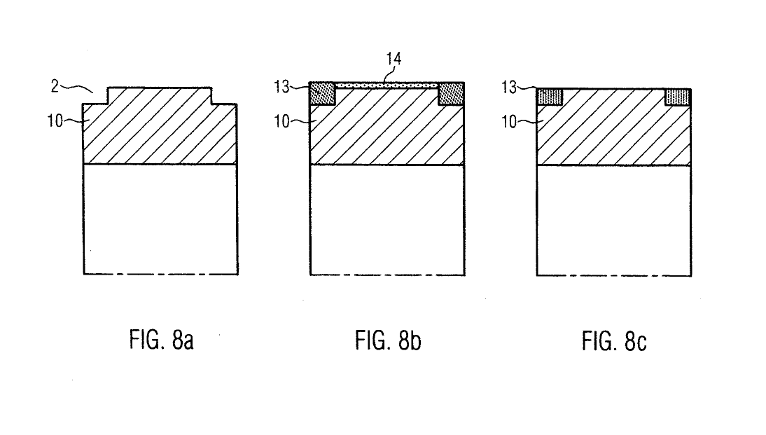

FIG. 8 shows a further embodiment in the case of which the diameter of the base body 10 is first reduced to a predetermined extent by machining in the region of the opposed edge areas 2, as shown in FIG. 8a; i.e., in correspondence with the first embodiment described. Other than in the case of the first embodiment, a highly wear resistant material in the form of a bulk powder 13 comprising at least one component is applied instead of the plate-shaped material elements 5, so as to form a planar and continuous edge zone 14 (cf. FIG. 8b). The powder mixture can here be applied such that it is not only applied to the interior of the recesses of the edge areas but also to the bridge-shaped section 3 located between the recesses, so that a uniform surface consisting of the bulk powder 13 is preferably accomplished on the whole base body.

After the application of the bulk powder 13 to the reduced-diameter edge areas 2 and/or the section 3 between the edge areas, the material is bonded to the base body 10 by hot isostatic pressing. Subsequently, the bridge-shaped section 3 between the edge areas 2 is, as has already been described in the preceding embodiments, subjected to pocket milling, so that the surface of this area extends below the surface of the surface formed by the one-component bulk powder. Following this, holes 8 can be formed and pin-shaped elements 9 can be fitted in, analogously to the above described methods.

One of the advantages of forming the powder mixture across the whole base body is to be seen in the fact that a uniform surface is achieved on the press roller, so that the powder mixture is here not only limited to the previously formed recesses in the edge areas. The desired height can thus be achieved more easily during the filling step.

The above described embodiments can additionally have added thereto wear protection in the area of the lateral flanks of the press rollers. In this case, it proved to be particularly advantageous when the opposed edge areas, which have been reduced in diameter, are formed in a stepped shape; i.e., a more deeply recessed area 15 is formed directly adjacent the base body sides, said area 15 merging then in a second step with the normal recess. This deeply recessed area can be used for accommodating a lateral flank protection.

Preferably, the lateral flank protection 16 only extends up to the first step; i.e., after insertion of the lateral flank protection, the now filled deeply recessed area 15 only extends up to the surface of the reduced-diameter edge area 2 of the press roller. The additional wear protection is consequently applied, on the one hand, to the surface of the base body 10 and, on the other hand, to the surface of the lateral flank protection 16 so that a particularly good connection and, consequently, stability of the individual elements is here achieved.

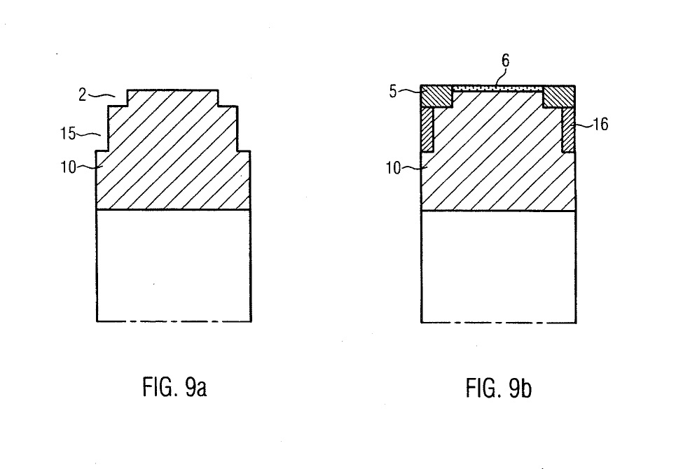

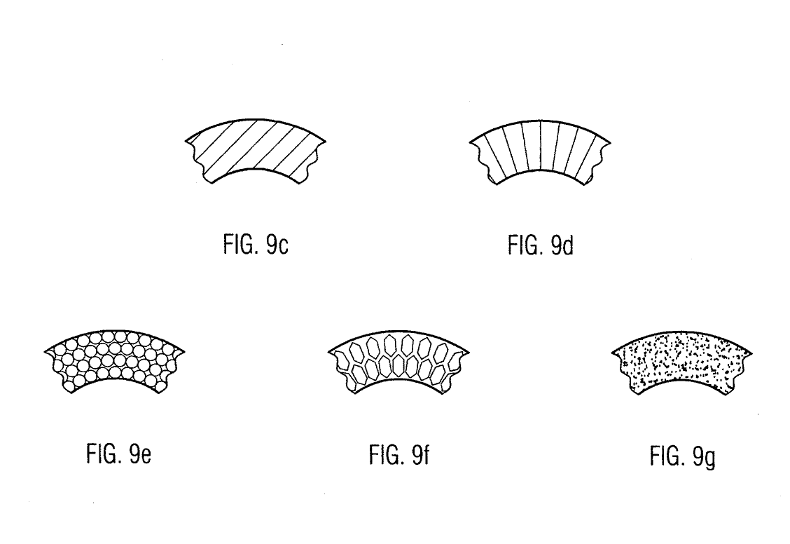

The lateral flank protection itself may here be applied as a whole in the form of a solid ring (FIG. 9c) or it may be applied in a divided fashion in the form of solid segments or segments produced by HIP, CIP or sintering processes (FIG. 9d). Furthermore, the wear protection elements for the lateral flank protection may also be applied in the form of tiles which have a circular cross-section or a polygonal cross-section and which have also been produced by HIP, CIP or sintering processes (FIG. 9e, FIG. 9f). The lateral flank may also be equipped with a one- or multi-component, highly wear resistant powder material (FIG. 9g), which may also be used as an intermediate gap material for the plate-shaped or tile-shaped elements. The material elements of the lateral flank protection and the wear protection elements on the surface, which have been described in the different variants of the preceding embodiments, are all applied to the press roller by hot isostatic pressing.

The formation of holes 8 in the base body 10 and the insertion of pin-shaped, highly wear resistant material elements 9 in the holes 8 formed preferably take place after hot isostatic pressing, analogously to the above described methods, so that these elements project beyond the surface of the base body 10 and are located in one plane with the surface of the plate-shaped material elements 5.

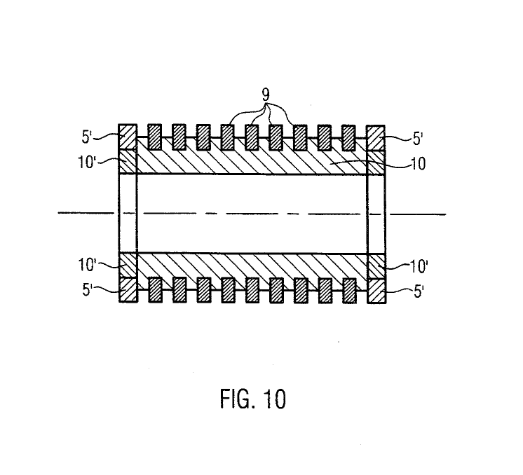

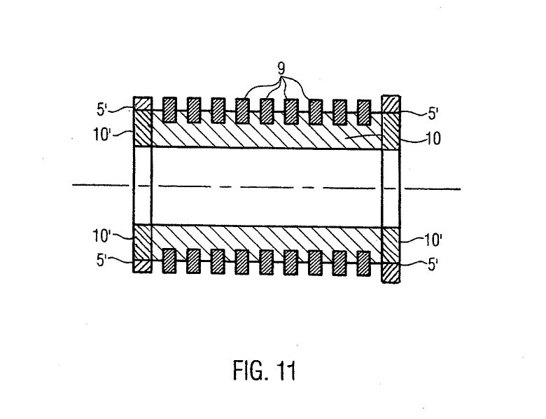

As can be seen in FIG. 10, the lateral flank protection may also be produced in the form of two rings 10′, which are attached to both end faces of the base body 10 provided with holes and with pin-shaped, highly wear resistant material elements 9. Analogously to the above described methods, the pin-shaped elements 9 may project beyond the surface of the base body 10 and they may be located in one plane with the surface of the plate-shaped material elements 5′ arranged on the rings 10′. Nevertheless, the plate-shaped material elements 9 may also be fully countersunk in the holes and positioned in one plane with the plate-shaped material elements 5′ placed on the thin discs. Analogously to the above described methods, the plate-shaped material elements 5′ may be fixed to the rings by HIP, CIP or sintering processes with or without pressure or by soldering methods. Furthermore, the rings 10′ may be produced such that they fully consist of powder metallurgically produced material or they may be produced as a base body with a powder metallurgical coating. On the basis of the solution described, an overall operating width of the press roller is obtained, which is composed of the width of the base body 10 equipped with pins and of the width of the lateral flank protection rings 10′ provided on both sides. The thickness of the lateral flank protection rings provided on either side of the base body is, per ring, 1.5 to 15% of the overall operating width of the press roller.

A further embodiment of the press roller is shown in FIG. 11. Also this embodiment comprises two rings 10′, which are arranged on the end faces of the rings 10. The two rings 10′ have here the same height as the surface of the rings 10, so that the rings 10, 10′ define a common surface. Analogously to the above described embodiment, the rings 10′ have arranged thereon the plate-shaped material elements 5′, which project beyond the surface of the base body 10.

As has already been described, holes are arranged in the area of the ring 10. In the holes, pin-shaped material elements 9 are arranged; i.e., they are arranged such that they are either fully countersunk in the holes or extend beyond the surface of the base body 10. The surfaces of the plate-shaped material elements 5′ themselves may be arranged, as shown on the left-hand side of FIG. 11, in one plane with the pin-shaped material elements 9, or they may, as shown on the right-hand side of FIG. 11, extend beyond the surface of the pin-shaped material elements 9; i.e., the surface of the pin-shaped material elements 9 is arranged below the surface of the plate-shaped elements 5′ in this case. The different structural designs of the plate-shaped material elements 5′ on the rings 10′ serve here only explanatory purposes. During operation the two opposed rings 10′ have identical structural designs.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-17. (canceled)

18. A roller press for processing highly abrasive materials, the roller press comprising at least two press rollers (1), each press roller (1) being provided with a wear protection layer arranged on a base body (10), said wear protection layer (4) comprising plate-shaped (5) and pin-shaped (9) wear resistant material elements, the plate-shaped wear resistant material elements being arranged on two opposed edge areas (2) of each base body (10) and the pin-shaped wear resistant material elements being arranged in a section of each press roller (1) extending between the edge areas, wherein the plate-shaped wear resistant material elements are configured as tiles having a quadrangular, pentagonal or hexagonal contour and are applied to a surface of each base body by a hot isostatic pressing operation.

19. The roller press according to claim 18, wherein the edge areas (2) occupy 5 to 25% of the overall area of the wear protection layer.

20. The roller press according to claim 18, wherein the plate-shaped material elements (5) comprises metal-matrix composites with up to 80% by weight of coarse further phases selected from the group consisting of carbides, borides and nitrides, and/or the pin-shaped material elements (9) comprise hard metal or of hard metal-like materials.

21. The roller press according to claim 18, wherein the pin-shaped material elements (9) are releasably installed in holes (8) in each base body.

22. The roller press according to claim 18, wherein surfaces of the pin-shaped material elements (9) and surfaces of the plate-shaped material elements (5) are arranged in one plane.

23. The roller press according to claim 18, wherein the edge areas have arranged between them an additional zone material whose surface is arranged below a surface of the pin-shaped material elements or in one plane therewith.

24. The roller press according to claim 18, wherein, in the area of the edge areas (2), a diameter of each base body (10) is reduced to a predetermined extent prior to application of the plate-shaped material elements (5) so as to obtain at least one step, and wherein the plate-shaped material elements (5) extend beyond an original height of the edge areas (2).

25. The roller press according to claim 18, wherein the base body of each press roller (1) is formed of at least two base body segments which define a closed ring and which are releasably arranged on a base element.

26. The roller press according to claim 25, wherein each base body is configured as a closed bandage and the wear protection layer (4) is applied thereto, the closed bandage being arranged on the base element of the press roller (1) in form-fit engagement or in frictional engagement therewith and which is associated with the base element.

27. The roller press according to claim 18, wherein additional wear elements are arranged in lateral surfaces of each base body below the plate-shaped wear resistant material elements in reception openings formed in the lateral surfaces.

28. The roller press according to claim 27, wherein the lateral wear protection elements are configured as plate-shaped elements.

29. The roller press according to claim 18, wherein the base body of each press rollers comprises a plurality of rings (10, 10′) are arranged on a base element of the press roller in form-fit engagement or in frictional engagement therewith, the respective edge areas (2) each being formed by a separate ring (10′) whose circumference has applied thereto the plate-shaped material elements (5′).

30. The roller press according to claim 29, wherein the rings (10, 10′) are equal in height.

31. The roller press according to claim 29, wherein a surface of the plate-shaped material elements (5) is arranged above a surface of the pin-shaped material elements (9).

32. A method of producing a wear protection layer for a roller press used for processing highly abrasive materials, the method comprising the steps of:
a) pre-machining a base body of a press roller so as to obtain a planar surface;
b) applying plate-shaped, highly wear resistant material elements to two opposed edge areas of the pre-machined base body, the plate-shaped material elements having been produced by sintering, cold isostatic pressing (CIP) or hot isostatic pressing (HIP);
c) filling intermediate gaps between the plate-shaped material elements with an intermediate gap material comprising a wear resistant, one-component material or a wear resistant, multi-component material;
d) filling a base body section arranged between the edge areas with a zone material comprising a wear resistant, one-component material or a wear resistant, multi-component material;
e) applying the plate-shaped material elements, the zone material and the intermediate gap material to the base body by hot isostatic pressing, so that a surface of edge elements formed by the plate-shaped material elements, a surface of the zone material and a surface of the intermediate gap material extend substantially in one plane;
f) forming holes in the zone material arranged between the edge elements and in the base body of the press roller, and
g) inserting pin-shaped, highly wear resistant material elements in the formed holes.

33. The method according to claim 32, wherein, after hot isostatic pressing, the zone material located between the edge elements is machined to reduce a diameter so that a resultant surface of the zone material is located lower than the surface of the edge elements by a predetermined amount, and wherein the pin-shaped material elements are arranged in the formed holes formed such that a surface of the pin-shaped material elements extends beyond the surface of the zone material.

34. A method according to claim 32, wherein additional recesses are formed in lateral surfaces of the base body below the edge elements to be applied so as to accommodate additional wear elements.
